(19) United States
(12) Patent Application Publication
(10) Pub. No.: US 2025/0184402 A1
(43) Pub. Date: Jun. 5, 2025

(54) SERVICE REQUEST HANDLING

(71) Applicant: Telefonaktiebolaget LM Ericsson (publ), Stockholm (SE)

(72) Inventors: Maria Cruz BARTOLOME RODRIGO, Torremocha de Jarama Madrid (ES); Emiliano MERINO VAZQUEZ, Madrid, Madrid (ES)

(73) Assignee: Telefonaktiebolaget LM Ericsson (publ), Stockholm (SE)

(21) Appl. No.: 18/840,819

(22) PCT Filed: Feb. 21, 2023
(86) PCT No.: PCT/EP2023/054288

§ 371 Date: Aug. 22, 2024

(30) Foreign Application Priority Data
Feb. 23, 2022 (EP) 22382155.4

(51) Int. Cl. H04L 67/51; H04L 67/02; H04L 67/56

(52) U.S. Cl. CPC H04L 67/51; H04L 67/02; H04L 67/56

(57) ABSTRACT

There is provided a method for handling a service request in a network. The method is performed by a first network function (NF) node of a service consumer. The first NF node initiates transmission (202) of a service request towards a first service communication proxy (SCP) node that is configured to operate as an SCP between the first NF node and a plurality of second NF nodes of one or more service producers. The service request is for a service requested by the first NF node. The service request comprises an indication that the service request is to be transmitted to one or more second NF nodes of the plurality of second NF nodes for the service request to be applied to all wireless devices served by the plurality of second NF nodes.

### TECHNICAL FIELD

The disclosure relates to methods for handling a service request in a network and nodes configured to operate in accordance with those methods.

### BACKGROUND

There exist various techniques for handling a request for a service in a network. A service request is generally from a consumer of the service (“service consumer”) to a producer of the service (“service producer”). For example, a service request may be from a network function (NF) node of a service consumer to an NF node of a service producer. The NF node of the service consumer and the NF node of the service producer can communicate directly or indirectly. This is referred to as direct communication and indirect communication respectively. In the case of indirect communication, the NF node of the service consumer and the NF node of the service producer may communicate via a service communication proxy (SCP) node.

FIG. 1A-D illustrates different existing systems for handling service requests, as set out in 3GPP TS 23.501 V17.3.0. In more detail, FIGS. 1A and 1B illustrate systems that use direct communication, while FIGS. 1C and 1D illustrate systems that use indirect communication.

In the systems illustrated in FIGS. 1A and 1B, a service request is sent directly from the NF node of the service consumer to the NF node of the service producer. A response to the service request is sent directly from the NF node of the service producer to the NF node of the service consumer. Similarly, any subsequent service requests are sent directly from the NF node of the service consumer to the NF node of the service producer. The system illustrated in FIG. 1B also comprises a network repository function (NRF) node. Thus, in the system illustrated in FIG. 1B, the NF node of the service consumer can query the NRF node to discover suitable NF nodes of the service producer to which to send the service request. In response to such a query, the NF node of the service consumer can receive an NF profile for one or more NF nodes of the service producer and, based on the received NF profile(s) can select an NF node of the service producer to which to send the service request. In the system illustrated in FIG. 1A, the NRF node is not used and instead the NF node of the service consumer may be configured with the NF profile(s) of the NF node(s) of the service producer.

In the systems illustrated in FIGS. 1C and 1D, a service request is sent indirectly from the NF node of the service consumer to the NF node of the service producer via a service communication proxy (SCP) node. A response to the service request is sent indirectly from the NF node of the service producer to the NF node of the service consumer via the SCP node. Similarly, any subsequent service requests are sent indirectly from the NF node of the service consumer to the NF node of the service producer via the SCP node. The systems illustrated in FIGS. 1C and 1D also comprise an NRF node.

In the system illustrated in FIG. 1C, the NF node of the service consumer can query the NRF node to discover suitable NF nodes of the service producer to which to send the service request. In response to such a query, the NF node of the service consumer can receive an NF profile for one or more NF nodes of the service producer and, based on the received NF profile(s) can select an NF node of the service producer to which to send the service request. In this case, the service request sent from the NF node of the service consumer to the SCP node comprises the address of the selected NF node of the service producer. The NF node of the service consumer can forward the service request without performing any further discovery or selection. In case the selected NF node of the service producer is not accessible for any reason, it may be up to the NF node of the service consumer to find an alternative. In other cases, the SCP node may communicate with the NRF node to acquire selection parameters (e.g. location, capacity, etc.) and the SCP node may select an NF node of the service producer to which to send the service request.

In the system illustrated in FIG. 1D, the NF node of the service consumer does not carry out the discovery or selection process. Instead, the NF node of the service consumer adds any necessary discovery and selection parameters (required to find a suitable NF node of the service producer) to the service request that it sends via the SCP node. The SCP node uses the request address and the discovery and selection parameters in the service request to route the service request to a suitable NF node of the service producer. Thus, in the system illustrated in FIG. 1D, where indirect communication with delegated discovery is used, the NF node of the service consumer sends the service request to the SCP node and provides within the service request to the SCP node the discovery and selection parameters necessary to discover and select an NF node of a service producer. The SCP node can perform discovery with the NRF node to discover a target NF node of the service producer to which to route the service request. The SCP node can discover a target NF node of the service producer in the manner indicated in 3GPP TS 23.502 V17.3.0.

For the fifth generation core (5GC), from Release 16, the SCP node is included as a network element to allow indirect communication between an NF node of a service consumer and an NF node of a service producer. That is, the SCP node can be used in indirect routing scenarios. The indirect communication that is used can be either of the two indirect communications options described earlier with reference to FIGS. 1C and 1D. In the 5GC, the SCP node can be an NF node that provides centralised capabilities, such as service based interface (SBI) routing, NF discovery and selection, failover, message screening, etc.

In existing techniques, the SCP node does not have 5GC service knowledge. In other words, the SCP node is not service aware. This means that the SCP node performs its functionality being service/application agnostic.

### SUMMARY

It can be problematic that the SCP node does not have 5GC service knowledge. For example, in some existing techniques, certain 5GC services allow a sender (e.g. an NF node of a service consumer) to send a service request that is intended to target any user equipment (UE) or all UEs in a network, e.g. a public land mobile network (PLMN). In this case, the NF node of the service consumer may indicate (e.g. on the payload/content of the service request) that the service request is to be applied to all UEs. However, in these existing techniques, the SCP node is not aware that the service request is intended to target all UEs since, as mentioned above, the SCP node is not service-aware. Instead, the SCP node may select any NF node (or instance of NF node) of one or more discovered NF nodes (or instances of NF nodes) of one or more service producers and proxy the service request to that selected NF node (or instance of NF node). This can result in the service request only being applied partially, e.g. to a subset of UEs instead of all UEs. Thus, the service request is not applied in line with the needs of the NF node of the service consumer.

It is an object of the disclosure to obviate or eliminate at least some of the above-described disadvantages associated with existing techniques.

Therefore, according to an aspect of the disclosure, there is provided a first method for handling a service request in a network. The first method is performed by a first network function (NF) node of a service consumer. The first method comprises initiating transmission of a service request towards a first service communication proxy (SCP) node that is configured to operate as an SCP between the first NF node and a plurality of second NF nodes of one or more service producers. The service request is for a service requested by the first NF node. The service request comprises an indication that the service request is to be transmitted to one or more second NF nodes of the plurality of second NF nodes for the service request to be applied to all wireless devices served by the plurality of second NF nodes.

According to another aspect of the disclosure, there is also provided a first NF node comprising processing circuitry configured to operate in accordance with the first method described in respect of the first NF node. In some embodiments, the first NF node may comprise at least one memory for storing instructions which, when executed by the processing circuitry, cause the first NF node to operate in accordance with the first method described in respect of the first NF node.

According to another aspect of the disclosure, there is also provided a second method for handling a service request in a network. The second method is performed by a first SCP node that is configured to operate as an SCP between a first NF node of a service consumer and a plurality of second NF nodes of one or more service producers. The second method comprises selecting one or more second NF nodes of the plurality of second NF nodes to which to transmit a service request received from the first NF node. The service request is for a service requested by the first NF node. The service request comprises an indication that the service request is to be transmitted to one or more second NF nodes of the plurality of second NF nodes for the service request to be applied to all wireless devices served by the plurality of second NF nodes.

According to another aspect of the disclosure, there is also provided a first SCP node comprising processing circuitry configured to operate in accordance with the second method described in respect of the first SCP node. In some embodiments, the first SCP node may comprise at least one memory for storing instructions which, when executed by the processing circuitry, cause the first SCP node to operate in accordance with the second method described in respect of the first SCP node.

According to another aspect of the disclosure, there is provided a method performed by a system. The method comprises the first method described in respect of the first NF node and the second method described in respect of the first SCP node.

According to another aspect of the disclosure, there is provided a system comprising at least one first NF node as described earlier and at least one first SCP node as described earlier.

According to another aspect of the disclosure, there is provided a computer program comprising instructions which, when executed by processing circuitry, cause the processing circuitry to perform the first method described in respect of the first NF node and/or the second method described in respect of the first SCP node.

According to another aspect of the disclosure, there is provided a computer program product, embodied on a non-transitory machine-readable medium, comprising instructions which are executable by processing circuitry to cause the processing circuitry to perform the first method described in respect of the first NF node and/or the second method described in respect of the first SCP node.

Thus, in the manner described, the service request can be applied fully to all wireless devices. In this way, the needs of the first NF node of the service consumer can be met.

Therefore, there is provided an improved technique for handling a service request in a network.

### BRIEF DESCRIPTION OF THE DRAWINGS

For a better understanding of the technique, and to show how it may be put into effect, reference will now be made, by way of example, to the accompanying drawings, in which:

FIG. 1A-D is a block diagram illustrating different existing systems;

FIG. 2 is a block diagram illustrating a first NF node according to an embodiment;

FIG. 3 is a block diagram illustrating a method performed by a first NF node according to an embodiment;

FIG. 4 is a block diagram illustrating a first SCP node according to an embodiment;

FIG. 5 is a block diagram illustrating a method performed by a first SCP node according to an embodiment;

FIG. 6 is a signalling diagram illustrating an exchange of signals in an example system; and

FIG. 7 is a signalling diagram illustrating an exchange of signals in a system according to an embodiment.

### DETAILED DESCRIPTION

Some of the embodiments contemplated herein will now be described more fully with reference to the accompanying drawings. Other embodiments, however, are contained within the scope of the subject-matter disclosed herein, the disclosed subject-matter should not be construed as limited to only the embodiments set forth herein; rather, these embodiments are provided by way of example to convey the scope of the subject-matter to those skilled in the art.

Herein, techniques for handling a service request in a network are described. A service request can also be referred to as a request for a service. Generally, a service is software intended to be managed for users. Herein, a service can be any type of service, such as a communication service (e.g. a notification service or a callback service), a context management (e.g. user equipment context management (UECM)) service, a data management (DM) service, or any other type of service. Herein, references to providing a service can refer to, for example, executing or running the service.

The techniques described herein can be used in respect of any network, such as any communications or telecommunications network, e.g. cellular network. The network may be a fifth generation (5G) network or any other generation network. In some embodiments, the network may be a core network or a radio access network (RAN). The techniques are implemented by a first network function (NF) node of a service consumer and a first service communication proxy (SCP) node. The first SCP node is a node that is configured to operate as an SCP between the first NF node and a plurality of second NF nodes of one or more service producers, e.g. of the same service producer or one or more different service producers. In some embodiments, the plurality of second NF nodes referred to herein can comprise one or more unified data management (UDM) nodes, one or more user data repository (UDR) nodes, one or more session management function (SMF) nodes, and/or any other node(s) of one or more service producers.

An NF is a third generation partnership project (3GPP) adopted, or 3GPP defined, processing function in a network, which has defined functional behaviour and 3GPP defined interfaces. An NF can be implemented either as a network element on a dedicated hardware, as a software instance running on a dedicated hardware, or as a virtualised function instantiated on an appropriate platform, e.g. on a cloud infrastructure. Herein, the term “node” in relation to an “NF node” will be understood to cover each of these scenarios. Herein, references to a plurality of NF nodes may refer to, for example, functionally equivalent instances of NF nodes.

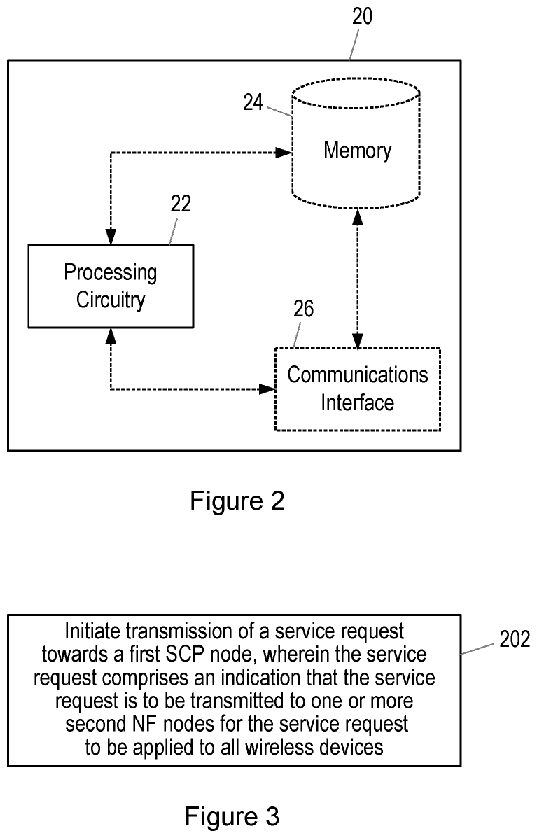

FIG. 2 illustrates a first NF node 20 of a service consumer in accordance with an embodiment. The first NF node 20 is for handling a service request in a network. In some embodiments, the first NF node 20 referred to herein can refer to equipment capable, configured, arranged and/or operable to communicate directly or indirectly with the first SCP node referred to herein, and/or with other nodes or equipment to enable and/or to perform the functionality described herein. In some embodiments, the first NF node 20 referred to herein can, for example, be a physical node (e.g. a physical machine or server) or a virtual node (e.g. a virtual machine, VM). In some embodiments, the first NF node 20 referred to herein can be a wireless device, e.g. a user equipment (UE). In some embodiments, the service consumer referred to herein can be a network operator, such as a mobile network operator (MNO).

As illustrated in FIG. 2, the first NF node 20 comprises processing circuitry (or logic) 22. The processing circuitry 22 controls the operation of the first NF node 20 and can implement the method described herein in respect of the first NF node 20. The processing circuitry 22 can be configured or programmed to control the first NF node 20 in the manner described herein. The processing circuitry 22 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the first NF node 20. In some embodiments, the processing circuitry 22 can be configured to run software to perform the method described herein in respect of the first NF node 20. The software may be containerised according to some embodiments. Thus, in some embodiments, the processing circuitry 22 may be configured to run a container to perform the method described herein in respect of the first NF node 20.

Briefly, the processing circuitry 22 of the first NF node 20 is configured to initiate transmission of a service request towards a first SCP node that is configured to operate as an SCP between the first NF node and a plurality of second NF nodes of one or more service producers. The service request is for a service requested by the first NF node. The service request comprises an indication that the service request is to be transmitted to one or more second NF nodes of the plurality of second NF nodes for the service request to be applied to all wireless devices served by the plurality of second NF nodes.

Herein, the term “initiate” can mean, for example, cause or establish. Thus, the processing circuitry 22 of the first NF node 20 can be configured to itself transmit the service request (e.g. via a communications interface 26 of the first NF node 20) or can be configured to cause another node to transmit the service request.

As illustrated in FIG. 2, in some embodiments, the first NF node 20 may optionally comprise a memory 24. The memory 24 of the first NF node 20 can comprise a volatile memory or a non-volatile memory. In some embodiments, the memory 24 of the first NF node 20 may comprise a non-transitory media. Examples of the memory 24 of the first NF node 20 include, but are not limited to, a random access memory (RAM), a read only memory (ROM), a mass storage media such as a hard disk, a removable storage media such as a compact disk (CD) or a digital versatile disk (DVD), and/or any other memory.

The processing circuitry 22 of the first NF node 20 can be communicatively coupled (e.g. connected) to the memory 24 of the first NF node 20. In some embodiments, the memory 24 of the first NF node 20 may be for storing program code or instructions which, when executed by the processing circuitry 22 of the first NF node 20, cause the first NF node 20 to operate in the manner described herein in respect of the first NF node 20. For example, in some embodiments, the memory 24 of the first NF node 20 may be configured to store program code or instructions that can be executed by the processing circuitry 22 of the first NF node 20 to cause the first NF node 20 to operate in accordance with the method described herein in respect of the first NF node 20. Alternatively or in addition, the memory 24 of the first NF node 20 can be configured to store any information, data, messages, requests, responses, indications, notifications, signals, or similar, that are described herein. The processing circuitry 22 of the first NF node 20 may be configured to control the memory 24 of the first NF node 20 to store any of the information, data, messages, requests, responses, indications, notifications, signals, or similar, that are described herein.

In some embodiments, as illustrated in FIG. 2, the first NF node 20 may optionally comprise a communications interface 26. The communications interface 26 of the first NF node 20 can be communicatively coupled (e.g. connected) to the processing circuitry 22 of the first NF node 20 and/or the memory 24 of the first NF node 20. The communications interface 26 of the first NF node 20 may be operable to allow the processing circuitry 22 of the first NF node 20 to communicate with the memory 24 of the first NF node 20 and/or vice versa. Similarly, the communications interface 26 of the first NF node 20 may be operable to allow the processing circuitry 22 of the first NF node 20 to communicate with any one or more nodes (e.g. the first SCP node) referred to herein and/or any other node. The communications interface 26 of the first NF node 20 can be configured to transmit and/or receive any of the information, data, messages, requests, responses, indications, notifications, signals, or similar, that are described herein. In some embodiments, the processing circuitry 22 of the first NF node 20 may be configured to control the communications interface 26 of the first NF node 20 to transmit and/or receive any of the information, data, messages, requests, responses, indications, notifications, signals, or similar, that are described herein.

Although the first NF node 20 is illustrated in FIG. 2 as comprising a single memory 24, it will be appreciated that the first NF node 20 may comprise at least one memory (i.e. a single memory or a plurality of memories) 24 that operate in the manner described herein. Similarly, although the first NF node 20 is illustrated in FIG. 2 as comprising a single communications interface 26, it will be appreciated that the first NF node 20 may comprise at least one communications interface (i.e. a single communications interface or a plurality of communications interfaces) 26 that operate in the manner described herein. It will also be appreciated that FIG. 2 only shows the components required to illustrate an embodiment of the first NF node 20 and, in practical implementations, the first NF node 20 may comprise additional or alternative components to those shown.

FIG. 3 illustrates a first method performed by the first NF node 20 in accordance with an embodiment. The first method is for handling a service request in a network. The first NF node 20 described earlier with reference to FIG. 2 can be configured to operate in accordance with the method of FIG. 3. The method can be performed by or under the control of the processing circuitry 22 of the first NF node 20 according to some embodiments.

With reference to FIG. 3, as illustrated at block 202, transmission of a service request is initiated towards a first SCP node that is configured to operate as an SCP between the first NF node 20 and a plurality of second NF nodes of one or more service producers. The service request is for a service requested by the first NF node 20. The service request comprises an indication (or instruction) that the service request is to be transmitted to one or more second NF nodes of the plurality of second NF nodes for the service request to be applied to all wireless devices served by the plurality of second NF nodes. The one or more second NF nodes can comprise a single second NF node or multiple NF nodes. In embodiments where the service request comprises an indication that the service request is to be transmitted to multiple second NF nodes of the plurality of second NF nodes, the indication can also be referred to herein as a “forking” indication. For example, in these embodiments, it can be said that the service request is to be “forked” to the multiple second NF nodes.

The wireless devices referred to herein can be wireless devices in a fifth generation core (5GC) network. In some embodiments, the wireless devices referred to herein can be in a single public land mobile network (PLMN) or a plurality of PLMNs. In some embodiments, the service referred to herein can be any of the example services referred to earlier. In a more specific embodiment, the service referred to herein can be a service that provides a notification to the first NF node 20 of a change to an international mobile equipment identity (IMEI) or a permanent equipment identifier (PEI) for any of the wireless devices. In another more specific embodiment, the service can be a service that provides a notification to the first NF node 20 of any of the wireless devices moving to a different PLMN. However, these are only some example use cases and the techniques described herein are also applicable to many other use cases.

In some embodiments, the service request referred to herein may comprise a first hypertext transfer protocol (HTTP) header and the first HTTP header can comprise the indication.

In some embodiments, the service request may comprise a criterion on the basis of which the one or more second NF nodes are to be selected by the first SCP node. In embodiments where the service request comprises an indication that the service request is to be transmitted to multiple second NF nodes of the plurality of second NF nodes, the criterion can also be referred to herein as a “forking method”. For example, in these embodiments, it can be said that the service request comprises a forking method on the basis of which the multiple second NF nodes are to be selected.

In some embodiments, the criterion (e.g. forking method) may be absent from the service request. In these embodiments, the criterion may already be configured in the first SCP node 10, all second NF nodes may be selected or any other suitable method can be used to select the one or more second NF nodes, e.g. the selection can be based on any existing technique and a person skilled in the art will be aware of various techniques in this regard. For example, the selection can be based on the health of the plurality of second NF nodes 30, 40, 50, 60 (where the healthiest one or more second NF nodes are selected), the distance between the first NF node 20 and the plurality of second NF nodes 30, 40, 50, 60 (where the one or more second NF nodes that are closest to the first NF node are selected), the load on the plurality of second NF nodes 30, 40, 50, 60 (where the one or more second NF nodes having the lowest load are selected), the capacity of the plurality of second NF nodes 30, 40, 50, 60 (where the one or more second NF nodes having the largest available capacity are selected), and/or any other selection criteria.

In some embodiments, the service request referred to herein may comprise a second HTTP header and the second HTTP header can comprise the criterion. The second HTTP header referred to herein can be the same header as the first HTTP header referred to herein or a different header from the first HTTP header referred to herein. The first HTTP header referred to herein and/or the second HTTP header referred to herein can be a (new) custom header, rather than an existing header. For example, the header can be one that is yet to be standardised. Although HTTP headers have been provided as an example, it will be understood that any other type of header may be used for the first and/or second HTTP headers referred to herein.

In some embodiments, the criterion referred to herein may be that the one or more second NF nodes are to comprise all second NF nodes of the plurality of second NF nodes. In other embodiments, the criterion referred to herein may be that the one or more second NF nodes are to comprise a second NF node that has a predefined group identifier or at least two second NF nodes that have different group identifiers, and/or a second NF node that has a predefined set identifier or at least two second NF nodes that have different set identifiers, and/or a second NF node that has a predefined service set identifier or at least two second NF nodes that have different service set identifiers.

A group identifier can be referred to in the art as an “NfGroupId”. A group identifier of a second NF node of a service producer can identify a group of second NF nodes (e.g. of one or more service producers) to which the second NF node belongs. This group of second NF nodes can be responsible for managing one or more wireless devices, e.g. one or more of the wireless devices referred to earlier. In some embodiments, the one or more wireless devices managed by each group of second NF nodes may be different. That is, each wireless device may only be managed by one group of second NF nodes according to some embodiments. Thus, there may be a one to one relationship between a wireless device and a group of second NF nodes. In this way, groups of NF nodes can be used to split (or segment or partition) the network or, more specifically, the wireless devices in the network. There may be a single wireless device or multiple wireless devices managed by a group of second NF nodes. The one or more wireless devices can be identified by their respective subscription permanent identifier (SUPI).

Thus, according to some embodiments, the group identifier referred to herein can be defined as an identifier that identifies one or more second NF nodes (or instances thereof) managing a specific SUPI or a specific set of SUPIs. Some examples of a group identifier are defined in 3GPP TS 23.501 V17.3.0. For example, in embodiments where the plurality of second NF nodes referred to herein comprise one or more UDM nodes, the group identifier (“UDM Group ID”) can be defined as an identifier that identifies one or more UDM nodes (or instances thereof) managing a specific SUPI or a specific set of SUPIs. Similarly, in embodiments where the plurality of second NF nodes referred to herein comprise one or more UDR nodes, the group identifier (“UDR Group ID”) can be defined as an identifier that identifies one or more UDR nodes (or instances thereof) managing a specific SUPI or a specific set of SUPIs.

A set identifier can be referred to in the art as an “NfSetId”. A set identifier of a second NF node of a service producer identifies a set of second NF nodes (e.g. of one or more service producers) to which the second NF node belongs. The second NF nodes of a set can have one or more characteristics in common. For example, the second NF nodes of a set can be of the same type (e.g. they can all be UDR nodes, UDM nodes, SMF nodes, or another type of NF node), can support the same service(s), and/or can support the same network slice(s). The second NF nodes of a set may be deployed in different locations (e.g. different data centers) and/or have access to (or share) the same context data. The second NF nodes of a set can thus be interchangeable. Further definitions of a set identifier are provided in 3GPP TS 23.501 V17.3.0.

In some embodiments, a group of second NF nodes can comprise one or multiple sets of second NF nodes. That is, there may be a one to one relationship between a group and a set or there may be a one to N relationship between a group and a set. Thus, in some embodiments, the plurality of second NF nodes referred to herein can be split (or segmented or partitioned) into multiple groups and the second NF nodes of each group can be deployed in one or multiple sets. For example, a group of UDM nodes can comprise one or multiple sets of UDM nodes. Similarly, a group of UDR nodes can comprise one or multiple sets of UDR nodes. In some embodiments where a group of second NF nodes comprises multiple sets of second NF nodes, each set of second NF nodes may provide access to all of the wireless devices served by the second NF nodes of the group. That is, according to these embodiments, the splitting (or segmenting or partitioning) of the network or, more specifically, the wireless devices in the network is via the groups of second NF nodes, rather than the sets of NF nodes. In these embodiments, the sets of NF nodes do not split (or segment or partition) the network further. Instead, the sets of NF nodes can be used for resiliency.

A service set identifier can be referred to in the art as an “NfServiceSetId”. A service set identifier of a second NF node of a service producer identifies a set of services that the second NF node can provide. Herein, the set of services may be a set of service instances according to some embodiments and thus any features relating to a “service” may equally apply to a “service instance”. The set of services can be of the same type. The services of a set may have access to (or share) the same context data. The set of services can thus be interchangeable. Further definitions of a service set identifier are provided in 3GPP TS 23.003 V17.4.0 and 3GPP TS 23.501 V17.3.0.

Although not illustrated in FIG. 3, in some embodiments, the first method may comprise receiving a response to the service request from the first SCP node. The response can be indicative of whether the service request is complete or partially complete. The first NF node 20 (e.g. the processing circuitry 22 of the first NF node 20) can be configured to receive this response (e.g. via a communications interface 26 of the first NF node 20) according to some embodiments.

In some embodiments, the response can be indicative that the service request is complete when every second NF node, towards which transmission of the service request is initiated, has successfully executed the service request, and/or the response can be indicative that the service request is partially complete when not every second NF node, towards which transmission of the service request is initiated, has successfully executed the service request. In some embodiments where the response is indicative that the service request is partially complete, the response may comprise an indication of which one or more second NF nodes, towards which transmission of the service request is initiated, have not successfully executed the service request.

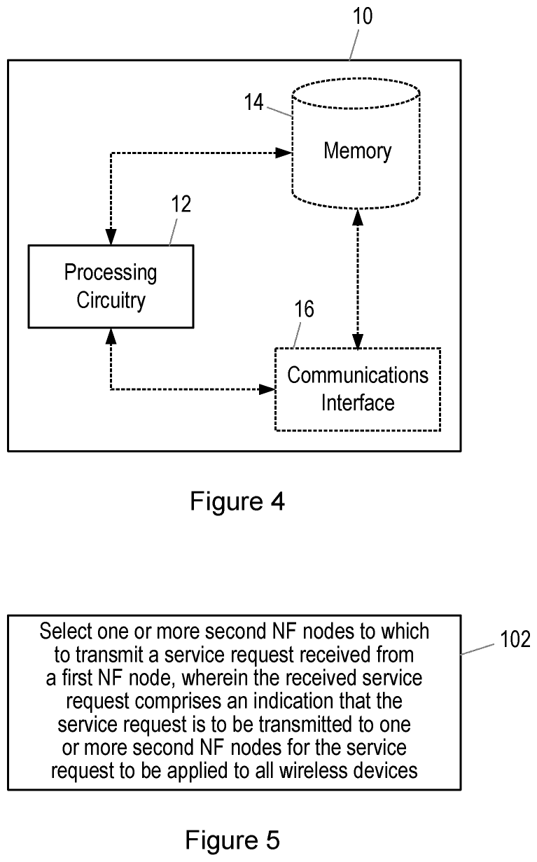

FIG. 4 illustrates a first SCP node 10 in accordance with an embodiment. The first SCP node 10 is for handling a service request in a network. The first SCP node 10 is configured to operate as an SCP between the first NF node 20 of the service consumer and the plurality of second NF nodes of the one or more service producers. In some embodiments, the first SCP node 10 referred to herein can refer to equipment capable, configured, arranged and/or operable to communicate directly or indirectly with the first NF node 20 referred to herein, any one or more of the plurality of second NF nodes referred to herein, and/or with other nodes or equipment to enable and/or to perform the functionality described herein. In some embodiments, the first SCP node 10 referred to herein can, for example, be a physical node (e.g. a physical machine or server) or a virtual node (e.g. a virtual machine, VM).

As illustrated in FIG. 4, the first SCP node 10 comprises processing circuitry (or logic) 12. The processing circuitry 12 controls the operation of the first SCP node 10 and can implement the method described herein in respect of the first SCP node 10. The processing circuitry 12 can be configured or programmed to control the first SCP node 10 in the manner described herein. The processing circuitry 12 can comprise one or more hardware components, such as one or more processors, one or more processing units, one or more multi-core processors and/or one or more modules. In particular implementations, each of the one or more hardware components can be configured to perform, or is for performing, individual or multiple steps of the method described herein in respect of the first SCP node 10. In some embodiments, the processing circuitry 12 can be configured to run software to perform the method described herein in respect of the first SCP node 10. The software may be containerised according to some embodiments. Thus, in some embodiments, the processing circuitry 12 may be configured to run a container to perform the method described herein in respect of the first SCP node 10.

Briefly, the processing circuitry 12 of the first SCP node 10 is configured to select one or more second NF nodes of the plurality of second NF nodes to which to transmit the service request received from the first NF node 20. The service request is for the service requested by the first NF node 20. The service request comprises the indication that the service request is to be transmitted to one or more second NF nodes of the plurality of second NF nodes for the service request to be applied to all wireless devices served by the plurality of second NF nodes.

As illustrated in FIG. 4, in some embodiments, the first SCP node 10 may optionally comprise a memory 14. The memory 14 of the first SCP node 10 can comprise a volatile memory or a non-volatile memory. In some embodiments, the memory 14 of the first SCP node 10 may comprise a non-transitory media. Examples of the memory 14 of the first SCP node 10 include, but are not limited to, a random access memory (RAM), a read only memory (ROM), a mass storage media such as a hard disk, a removable storage media such as a compact disk (CD) or a digital versatile disk (DVD), and/or any other memory.

The processing circuitry 12 of the first SCP node 10 can be communicatively coupled (e.g. connected) to the memory 14 of the first SCP node 10. In some embodiments, the memory 14 of the first SCP node 10 may be for storing program code or instructions which, when executed by the processing circuitry 12 of the first SCP node 10, cause the first SCP node 10 to operate in the manner described herein in respect of the first SCP node 10. For example, in some embodiments, the memory 14 of the first SCP node 10 may be configured to store program code or instructions that can be executed by the processing circuitry 12 of the first SCP node 10 to cause the first SCP node 10 to operate in accordance with the method described herein in respect of the first SCP node 10. Alternatively or in addition, the memory 14 of the first SCP node 10 can be configured to store any information, data, messages, requests, responses, indications, notifications, signals, or similar, that are described herein. The processing circuitry 12 of the first SCP node 10 may be configured to control the memory 14 of the first SCP node 10 to store any of the information, data, messages, requests, responses, indications, notifications, signals, or similar, that are described herein.

In some embodiments, as illustrated in FIG. 4, the first SCP node 10 may optionally comprise a communications interface 16. The communications interface 16 of the first SCP node 10 can be communicatively coupled (e.g. connected) to the processing circuitry 12 of the first SCP node 10 and/or the memory 14 of the first SCP node 10. The communications interface 16 of the first SCP node 10 may be operable to allow the processing circuitry 12 of the first SCP node 10 to communicate with the memory 14 of the first SCP node 10 and/or vice versa. Similarly, the communications interface 16 of the first SCP node 10 may be operable to allow the processing circuitry 12 of the first SCP node 10 to communicate with any one or more nodes (e.g. the first NF node 20 and/or any one or more of the plurality of second NF nodes) referred to herein and/or any other node. The communications interface 16 of the first SCP node 10 can be configured to transmit and/or receive any of the information, data, messages, requests, responses, indications, notifications, signals, or similar, that are described herein. In some embodiments, the processing circuitry 12 of the first SCP node 10 may be configured to control the communications interface 16 of the first SCP node 10 to transmit and/or receive any of the information, data, messages, requests, responses, indications, notifications, signals, or similar, that are described herein.

Although the first SCP node 10 is illustrated in FIG. 4 as comprising a single memory 14, it will be appreciated that the first SCP node 10 may comprise at least one memory (i.e. a single memory or a plurality of memories) 14 that operate in the manner described herein. Similarly, although the first SCP node 10 is illustrated in FIG. 4 as comprising a single communications interface 16, it will be appreciated that the first SCP node 10 may comprise at least one communications interface (i.e. a single communications interface or a plurality of communications interfaces) 16 that operate in the manner described herein. It will also be appreciated that FIG. 4 only shows the components required to illustrate an embodiment of the first SCP node 10 and, in practical implementations, the first SCP node 10 may comprise additional or alternative components to those shown.

FIG. 5 illustrates a second method performed by a first SCP node 10 in accordance with an embodiment. The second method is for handling a service request in a network. The first SCP node 10 described earlier with reference to FIG. 4 can be configured to operate in accordance with the second method of FIG. 5. The second method can be performed by or under the control of the processing circuitry 12 of the first SCP node 10 according to some embodiments.

With reference to FIG. 5, as illustrated at block 102, one or more second NF nodes of the plurality of second NF nodes are selected to which to transmit the service request received from the first NF node 20. The service request is for the service requested by the first NF node 20. The service request comprises the indication (or instruction) that the service request is to be transmitted to one or more second NF nodes of the plurality of second NF nodes for the service request to be applied to all wireless devices served by the plurality of second NF nodes.

As described earlier, in some embodiments, the service request may comprise a criterion on the basis of which the one or more second NF nodes are to be selected by the first SCP node 10. In these embodiments, selecting the one or more second NF nodes may comprise selecting the one or more second NF nodes based on the criterion.

In embodiments where the criterion is that the one or more second NF nodes are to comprise a second NF node that has a predefined group identifier, selecting the one or more second NF nodes may comprise selecting a second NF node that has the predefined group identifier or, in embodiments where the criterion is that the one or more second NF nodes are to comprise at least two second NF nodes that have different group identifiers, selecting the one or more second NF nodes may comprise selecting at least two second NF nodes that have different group identifiers. In some embodiments, there may only be one group of second NF nodes. In these embodiments, a second NF node may be selected from this one group. However, in other embodiments, there may be multiple groups of second NF nodes. In these embodiments, a second NF node may be selected from more than one (e.g. each) group.

Alternatively or in addition, in embodiments where the criterion is that the one or more second NF nodes are to comprise a second NF node that has a predefined set identifier, selecting the one or more second NF nodes may comprise selecting a second NF node that has the predefined set identifier or, in embodiments where the criterion is that the one or more second NF nodes are to comprise at least two second NF nodes that have different set identifiers, selecting the one or more second NF nodes may comprise selecting at least two second NF nodes that have different set identifiers. In some embodiments, there may only be one set of second NF nodes. In these embodiments, a second NF node may be selected from this one set. However, in other embodiments, there may be multiple sets of second NF nodes. In these embodiments, a second NF node may be selected from more than one (e.g. each) set.

Alternatively or in addition, in embodiments where the criterion is that the one or more second NF nodes are to comprise a second NF node that has a predefined service set identifier, selecting the one or more second NF nodes may comprise selecting a second NF node that has the predefined service set identifier or, in embodiments where the criterion is that the one or more second NF nodes are to comprise at least two second NF nodes that have different service set identifiers, selecting the one or more second NF nodes may comprise selecting at least two second NF nodes that have different service set identifiers.

A group identifier, a set identifier, and/or a service identifier for a second NF node may be included in a profile of the second NF node. Thus, the first SCP node 10 (or the processing circuitry 12 of the first SCP node 10) can acquire one or more of these identifiers from the profiles of each of the plurality of the second NF nodes according to some embodiments.

In embodiments where the criterion is that the one or more second NF nodes are to comprise all second NF nodes of the plurality of second NF nodes, selecting the one or more second NF nodes may comprise selecting all second NF nodes of the plurality of second NF nodes.

Although not illustrated in FIG. 5, in some embodiments, the second method may comprise checking the service request for the indication, e.g. prior to the selecting of the one or more second NF nodes. The first SCP node 10 (e.g. the processing circuitry 12 of the first SCP node 10) can be configured to perform this checking according to some embodiments. Although also not illustrated in FIG. 5, in some embodiments, the second method may comprise receiving the service request from the first NF node 20, e.g. prior to the checking of the service request and/or prior to the selecting of the one or more second NF nodes. The first SCP node 10 (e.g. the processing circuitry 12 of the first SCP node 10) can be configured to receive the service request (e.g. via the communications interface 16 of the first SCP node 10) according to some embodiments.

Although also not illustrated in FIG. 5, in some embodiments, the second method may comprise, prior to selecting the one or more second NF nodes, initiating transmission of a discovery request towards a network repository function (NRF) node. Generally, an NRF node is a node that provides NF service registration and discovery. An NRF node thus enables NF nodes to identify services offered by other NF nodes. Further definitions of an NRF node are provided in 3GPP TS 29.510 V16.5.0 and V17.2.0 and the NRF node described herein may be capable of operating in accordance with any of the methods described therein.

A discovery request can also be referred to as a request for discovery. The discovery request can be a request for information indicative of one or more second NF nodes for providing the service. In some of these embodiments, although not illustrated in FIG. 5, the second method may comprise receiving a discovery response from the NRF node. The discovery response can comprise information indicative of the plurality of second NF nodes for providing the service. In some embodiments, the first SCP node 10 (e.g. the processing circuitry 12 of the first SCP node 10) can be configured to initiate transmission of (e.g. itself transmit or cause another node to transmit) the discovery request towards the NRF node, such as via the communications interface 16 of the first SCP node 10. Similarly, in some embodiments, the first SCP node 10 (e.g. the processing circuitry 12 of the first SCP node 10) can be configured to receive the discovery request from the NRF node, such as via the communications interface 16 of the first SCP node 10. The first SCP node 10 (or the processing circuitry 12 of the first SCP node 10) can thus select one or more second NF nodes from the plurality of second NF nodes indicated by the information that the discovery response comprises. In some embodiments, the discovery response can comprise the earlier-mentioned profiles of the plurality of the second NF nodes.

In some embodiments, the first SCP node 10 may have stored (or cached, e.g. in the memory 14 of the first SCP node 10) information on previous discovery results. Thus, in these embodiments, discovery may not be needed. Instead, the first SCP node 10 (or the processing circuitry 12 of the first SCP node 10) may select one or more second NF nodes from the plurality of second NF nodes indicated by the stored information. In some embodiments, the earlier-mentioned profiles of the plurality of the second NF nodes may be stored (or cached, e.g. in the memory 14 of the first SCP node 10).

Although not illustrated in FIG. 5, in some embodiments, the second method may comprise initiating transmission of the service request towards the selected one or more second NF nodes. In some embodiments, the first SCP node 10 (e.g. the processing circuitry 12 of the first SCP node 10) can be configured to initiate transmission of (e.g. itself transmit or cause another node to transmit) the service request towards the selected one or more second NF nodes, such as via the communications interface 16 of the first SCP node 10.

Although also not illustrated in FIG. 5, in some embodiments, the second method may comprise, for each second NF node of the selected one or more second NF nodes that is unreachable, selecting an alternative second NF node of the plurality of second NF nodes for the service request to be applied to all wireless devices served by the plurality of second NF nodes. The first SCP node 10 (e.g. the processing circuitry 12 of the first SCP node 10) can be configured to perform this selection according to some embodiments. In some of these embodiments, selecting the alternative second NF node may comprise selecting the alternative second NF node based on the earlier described criterion. Although also not illustrated in FIG. 5, in some embodiments, the second method may comprise initiating transmission of the service request towards the selected alternative second NF node. In some embodiments, the first SCP node 10 (e.g. the processing circuitry 12 of the first SCP node 10) can be configured to initiate transmission of (e.g. itself transmit or cause another node to transmit) the service request towards the selected alternative second NF node, such as via the communications interface 16 of the first SCP node 10.

Although also not illustrated in FIG. 5, in some embodiments, the second method may comprise initiating transmission of a response to the service request towards the first NF node 20. The response can be indicative of whether the service request is complete or partially complete. In some embodiments, the first SCP node 10 (e.g. the processing circuitry 12 of the first SCP node 10) can be configured to initiate transmission of (e.g. itself transmit or cause another node to transmit) the response to the service request towards the first NF node 20, such as via the communications interface 16 of the first SCP node 10.

In some embodiments, the response can be indicative that the service request is complete when every second NF node, towards which transmission of the service request is initiated, has successfully executed the service request. Alternatively or in addition, the response can be indicative that the service request is partially complete when not every second NF node, towards which transmission of the service request is initiated, has successfully executed the service request. In some embodiments where the response is indicative that the service request is partially complete, the response may comprise an indication of which one or more second NF nodes, towards which transmission of the service request is initiated, have not successfully executed the service request.

In some embodiments, the first SCP node 10 referred to herein and the first NF node 20 referred to herein may be deployed in independent deployment units, and/or the first SCP node 10 referred to herein and any one or more of the plurality of second NF nodes referred to herein may be deployed in independent deployment units. Thus, an SCP node based on independent deployment units is possible, as described in 3GPP TS 23.501 V17.3.0. In other embodiments, the first SCP node 10 referred to herein may be deployed as a distributed network element. For example, in some embodiments, part (e.g. a service agent) of the first SCP node 10 referred to herein may be deployed in the same deployment unit as the first NF node 20 referred to herein, and/or part (e.g. a service agent) of the first SCP node 10 referred to herein may be deployed in the same deployment unit as any one or more of the plurality of second NF nodes referred to herein. Thus, an SCP node based on a service mesh is possible, as described in 3GPP TS 23.501 V17.3.0.

In some embodiments, at least one second SCP node may be configured to operate as an SCP between the first NF node 20 referred to herein and the first SCP node 10 referred to herein, and/or at least one third SCP node may be configured to operate as an SCP between the first SCP node 10 referred to herein and any one or more of the plurality of second NF nodes referred to herein. Thus, a multipath of SCP nodes is possible. In some embodiments, the first SCP node 10 referred to herein and the at least one second SCP node and/or the at least one third SCP node may be deployed in independent deployment units. In some embodiments, the at least one second SCP node and/or the at least one third SCP node may be deployed as distributed network elements.

In some embodiments involving an NRF node, an entity may comprise the first SCP node 10 referred to herein and the NRF node.

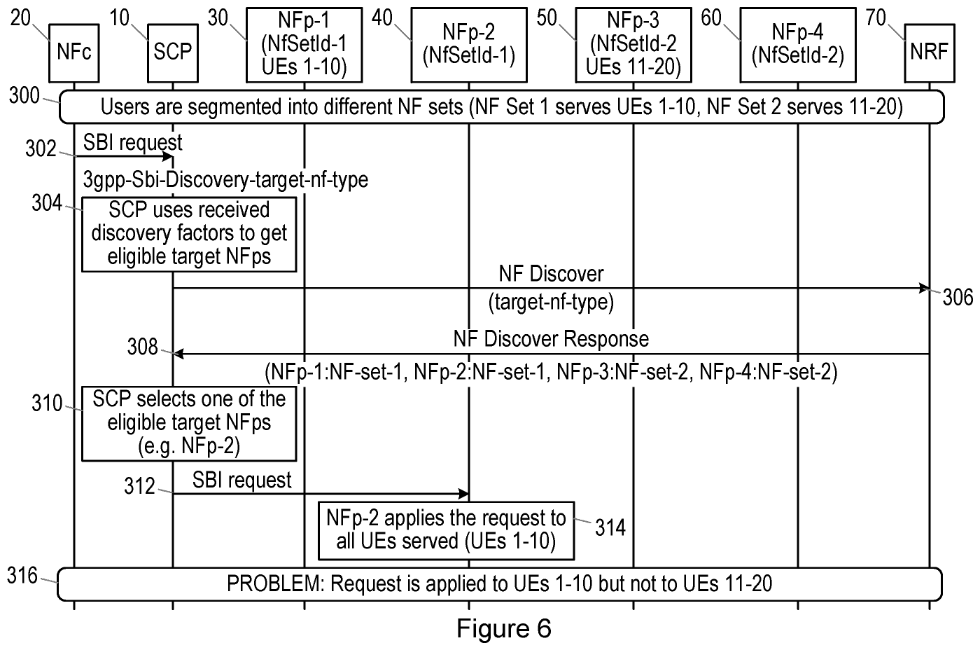

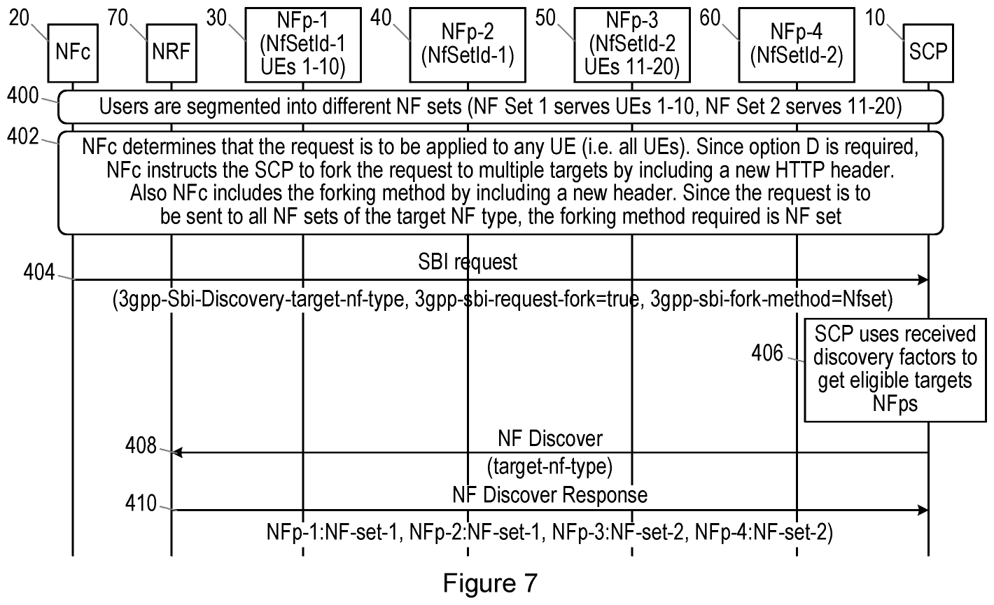

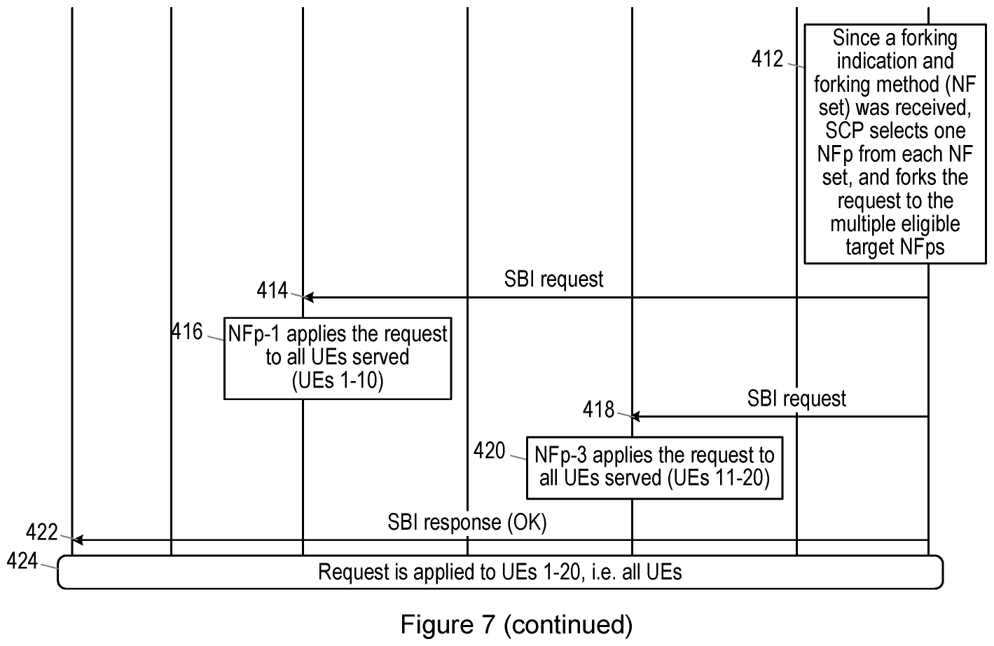

There is also provided a system comprising the first NF node 20 described herein and the first SCP node 10 described herein. A method performed by the system comprises the method described herein in respect of the first NF node 20 and the method described herein in respect of the first SCP node 10. Some example systems will now be described with reference to the signalling diagrams of FIGS. 6 and 7. As will become apparent from the description with reference to FIG. 6, there exists an issue with existing techniques and, as will become apparent from the description with reference to FIG. 7, this issue can be addressed using the technique described herein.

FIG. 6 is a signalling diagram illustrating an exchange of signals in an example system. The system illustrated in FIG. 6 comprises a first NF node 20, a first SCP node 10, a plurality of second NF nodes 30, 40, 50, 60 of one or more service producers, and an NRF node 70. The first SCP node 10 is configured to operate as an SCP between the first NF node 20 and the plurality of second NF nodes 30, 40, 50, 60. In the example illustrated in FIG. 6, the plurality of second NF nodes 30, 40, 50, 60 comprise four second NF nodes (i.e. “NFp-1”, “NFp-2”, “NFp-3”, “NFp-4”). However, it will be understood that the system illustrated in FIG. 6 can comprise one or more (i.e. any number of) second NF nodes. The plurality of second NF nodes 30, 40, 50, 60 can each be configured to provide a service.

As illustrated by block 300 of FIG. 6, the plurality of second NF nodes 30, 40, 50, 60 are segmented (or split) into a plurality of different sets. In particular, a first set of second NF nodes comprises the second NF node “NFp-1” 30 and the second NF node “NFp-2” 40, and a second set of second NF nodes comprises the second NF node “NFp-3” 50 and the second NF node “NFp-4” 60. The first set of second NF nodes is identified by a first set identifier (“NfSetId-1”) and the second set of second NF nodes is identified by a second set identifier (“NfSetId-2”). The first set of second NF nodes serves a first plurality of wireless devices (“UEs 1-10”) and the second set of second NF nodes serves a second plurality of wireless devices (“UEs 11-20”). The first plurality of wireless devices comprises different wireless devices from the second plurality of wireless devices.

As illustrated by arrow 302 of FIG. 6, the first NF node 20 transmits a service request towards the first SCP node 10. The first SCP node 10 thus receives the service request from the first NF node 20. The service request is for a service requested by the first NF node 20.

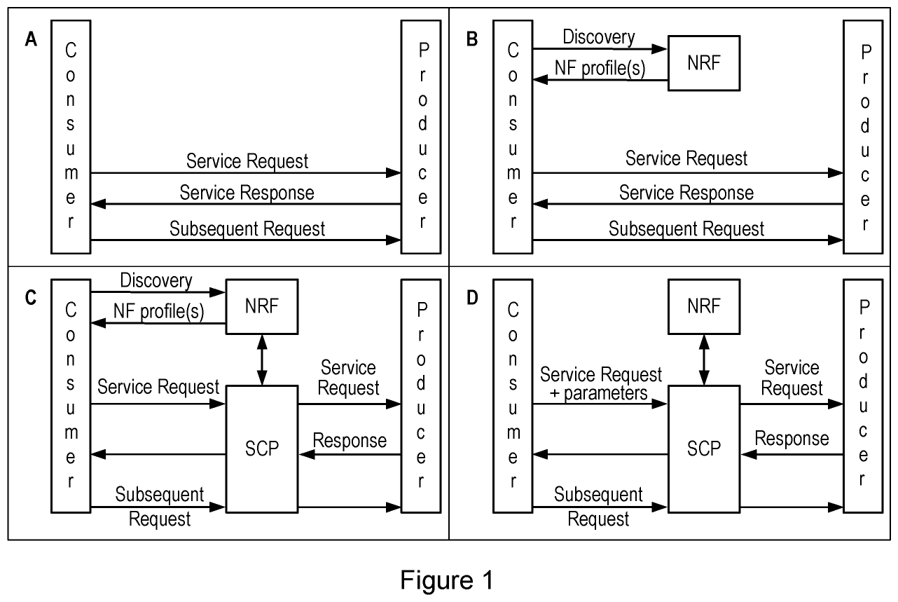

According to an indirect communication model with delegated discovery (e.g. as described earlier with reference to FIG. 1D), the first NF node 20 sends one or more discovery parameters (or factors) required to find one or more suitable second NF nodes and the first SCP node 10 can discover one or more second NF nodes via the NRF node 70 by using the received one or more discovery parameters.

Thus, in the embodiment illustrated in FIG. 6, the service request can comprise one or more discovery parameters (or factors) on the basis of which the first SCP node 10 is to discover one or more second NF nodes. In the example illustrated in FIG. 6, the one or more discovery parameters comprise a parameter indicative of a type of second NF node (“target-nf-type”). In other examples, the one or more discovery parameters can comprise one or more identifiers, where each identifier identifies a wireless device served by a second NF node that the first NF node 20 intends to reach. In some embodiments, the service request may comprise a header and the header can comprise the one or more parameters (e.g. “3gpp-Sbi-Discovery-target-nf-type” in the case of a parameter indicative of a type of second NF node).

As illustrated by block 304 of FIG. 6, the first SCP node 10 uses the received one or more discovery parameters to discover one or more eligible second NF nodes to target with the service request. In this way, the first SCP node 10 can select one or more proper second NF nodes to which to proxy the request. Thus, as illustrated by arrow 306 of FIG. 6, the first SCP node 10 transmits a discovery request towards the NRF node 70. The NRF node 70 thus receives the discovery request from the first SCP node 10. The discovery request is a request for information indicative of one or more second NF nodes for providing the service. The discovery request can comprise the one or more discovery parameters (e.g. “target-nf-type”).

As illustrated by arrow 308 of FIG. 6, the NRF node 70 transmits a discovery response towards the first SCP node 10. The first SCP node 10 thus receives the discovery response from the NRF node 70. The discovery response comprises information indicative of the plurality of second NF nodes 30, 40, 50, 60 (“NFp-1”, “NFp-2”, “NFp-3”, “NFp-4”) for providing the service. For example, the plurality of second NF nodes 30, 40, 50, 60 may each by of the same type as that identified by a discovery parameter of the one or more discovery parameters. The discovery response can also comprise information indicative of the set to which the plurality of second NF nodes 30, 40, 50, 60 belong, namely that the second NF nodes “NFp-1” 30 and “NFp-2” 40 belong to the first set of second NF nodes and the second NF nodes “NFp-3” 50 and “NFp-4” 60 belong to the second set of second NF nodes (e.g. “NFp-1:NF-set-1”, “NFp-2:NF-set-1”, “NFp-3:NF-set-2”, “NFp-4:NF-set-2).

As illustrated by block 310 of FIG. 6, the first SCP node 10 selects one or more second NF nodes of the plurality of second NF nodes 30, 40, 50, 60 to which to transmit the service request received from the first NF node 20. The selection can be based on any existing technique and a person skilled in the art will be aware of various techniques in this regard, such as any of those mentioned earlier. However, since the first SCP node 10 does not know that the service request is intended to target all UEs (e.g. the first SCP node 10 may not be service-aware), the first SCP node 10 may select any one or more second NF nodes of the plurality of second NF nodes 30, 40, 50, 60 to which to proxy the service request. In the example illustrated in FIG. 6, the first SCP node 10 selects the second NF node “NFp-2” 40.

Thus, as illustrated by arrow 312 of FIG. 6, the first SCP node 10 transmits the service request towards the selected second NF node “NFp-2” 40. The selected second NF node “NFp-2” 40 thus receives the service request. As illustrated by block 314 of FIG. 6, the selected second NF node “NFp-2” 40 applies the service request to all of the wireless devices (“UEs 1-10”) that it serves.

However, as illustrated by block 316 of FIG. 6, there is a problem because this means that the service request is only applied to some wireless devices (“UEs 1-10”) and not to other wireless devices (“UEs 11-20”). That is, since the first SCP node 10 is unaware that the service request is intended to target all UEs and thus selected any one or more second NF nodes of the plurality of second NF nodes 30, 40, 50, 60, the result is that the service request is only applied partially. As the service request is applied to only some wireless devices (“UEs 1-10”), the service will not be provided in respect of any other wireless devices (“UEs 11-20”). Thus, for example, if the service request is a subscription to IMEI change notifications, only some wireless devices (“UEs 1-10”) will be monitored to detect the event. The problem can be resolved by way of the technique described herein, such as in the manner illustrated in FIG. 7.

FIG. 7 is a signalling diagram illustrating an exchange of signals in a system according to an embodiment. The system illustrated in FIG. 7 comprises a first NF node 20 and a first SCP node 10. The first NF node 20 and a first SCP node 10 can be as described earlier with reference to FIGS. 2 to 5.

The system illustrated in FIG. 7 can also comprise a plurality of second NF nodes 30, 40, 50, 60 of one or more service producers. The system illustrated in FIG. 7 can further comprise an NRF node 70. The first SCP node 10 is configured to operate as an SCP between the first NF node 20 and the plurality of second NF nodes 30, 40, 50, 60. In the embodiment illustrated in FIG. 7, the plurality of second NF nodes 30, 40, 50, 60 comprise four second NF nodes (i.e. “NFp-1”, “NFp-2”, “NFp-3”, “NFp-4”). However, it will be understood that the system illustrated in FIG. 7 can comprise one or more (i.e. any number of) second NF nodes. The plurality of second NF nodes 30, 40, 50, 60 can each be configured to provide a service.

As illustrated by block 400 of FIG. 7, the plurality of second NF nodes 30, 40, 50, 60 are segmented (or split) into a plurality of different sets. In particular, a first set of second NF nodes comprises the second NF node “NFp-1” 30 and the second NF node “NFp-2” 40, and a second set of second NF nodes comprises the second NF node “NFp-3” 50 and the second NF node “NFp-4” 60. The first set of second NF nodes is identified by a first set identifier (“NfSetId-1”) and the second set of second NF nodes is identified by a second set identifier (“NfSetId-2”). The first set of second NF nodes serves a first plurality of wireless devices (“UEs 1-10”) and the second set of second NF nodes serves a second plurality of wireless devices (“UEs 11-20”). The first plurality of wireless devices comprises different wireless devices from the second plurality of wireless devices.

As illustrated by block 402 of FIG. 7, the first NF node 20 may determine that a service request is to be applied to all wireless devices served by the plurality of second NF nodes 30, 40, 50, 60. For example, the first NF node 20 may intend to send the service request to target all UEs (or any UEs). Since an indirect communication option with delegated discovery (e.g. as described earlier with reference to FIG. 1D) is required, the first NF node 20 can indicate to (or instruct) the first SCP node 10 to transmit the service request to one or more second NF nodes of the plurality of second NF nodes 30, 40, 50, 60 for the service request to be applied to all wireless devices served by the plurality of second NF nodes. For example, this may require the service request to be forked. That is, the service request may need to be sent to multiple target second NF nodes (or multiple service instances). In some embodiments, the first NF node 20 may also indicate to the first SCP node 10 a criterion on the basis of which the one or more second NF nodes are to be selected by the first SCP node 10. For example, the forking method may be indicated. The forking method can, for example, be to fork the service request to at least one second NF node in each set of second NF nodes.

As illustrated by arrow 404 of FIG. 7, the first NF node 20 transmits the service request towards the first SCP node 10. The first SCP node 10 thus receives the service request from the first NF node 20. The service request is for a service requested by the first NF node 20. In some embodiments, the service request may comprise one or more discovery parameters (or factors) on the basis of which the first SCP node 10 is to discover one or more second NF nodes. In the example illustrated in FIG. 7, the one or more discovery parameters comprise a parameter (“target-nf-type”) indicative of a type of second NF node. In some embodiments, the service request may comprise a header and the header can comprise the one or more parameters (e.g. “3gpp-sbi-discovery-target-nf-type” in the case of a parameter indicative of a type of second NF node).

The service request also comprises an indication (or instruction, e.g. “request-fork=true”) that the service request is to be transmitted to one or more second NF nodes of the plurality of second NF nodes 30, 40, 50, 60 for the service request to be applied to all wireless devices served by the plurality of second NF nodes 30, 40, 50, 60. This indication can be referred to as a “forking indication” in embodiments where the service request is to be transmitted to multiple second NF nodes. In some embodiments, the service request may comprise a header (e.g. a HTTP header) and the header can comprise the indication (e.g. “3gpp-sbi-request-fork=true”).

In some embodiments, the service request may also comprise an indication (e.g. on a payload/content of the service request) that the service request is to be applied to all wireless devices (e.g. in a PLMN). However, although the first NF node 20 has the knowledge about whether the service request is to reach all (or any) wireless devices, the service request does not have to comprise an indication of this specifically. In some embodiments, the service request does comprise such an indication but this is optional. Even in some embodiments where the service request comprises such an indication that the service request is to reach all wireless devices, this indication may be included in a JavaScript Object Notation (JSON) body. Thus, the first SCP node 10 may not be expected to read such an indication.

In some embodiments, the service request may also comprise the criterion (e.g. “fork-method=Nfset”) on the basis of which the one or more second NF nodes are to be selected by the first SCP node 10. This criterion can also be referred to as a “forking method” in embodiments where the service request is to be transmitted to multiple second NF nodes. In some embodiments, the service request may comprise a header (e.g. a HTTP header) and the header can comprise the criterion (e.g. “3gpp-sbi-fork-method=Nfset”). Thus, in some embodiments, together with the forking indication, the first NF node 20 may provide the forking method, which can be indicative of how the forking is to be performed by the first SCP node 10. For example, if the service request is to be forked to a second NF node within each set of second NF nodes (in embodiments where there are multiple sets of second NF nodes), the first NF node 20 may include “NF set” as the forking method.

As illustrated by block 406 of FIG. 7, the first SCP node 10 uses the received one or more discovery parameters to discover one or more eligible second NF nodes to target with the service request. Thus, as illustrated by arrow 408 of FIG. 7, the first SCP node 10 transmits a discovery request towards the NRF node 70. The NRF node 70 thus receives the discovery request from the first SCP node 10. The discovery request is a request for information indicative of one or more second NF nodes for providing the service. The discovery request can comprise the one or more discovery parameters (e.g. “target-nf-type”).

As illustrated by arrow 410 of FIG. 7, the NRF node 70 transmits a discovery response towards the first SCP node 10. The first SCP node 10 thus receives the discovery response from the NRF node 70. The discovery response comprises information indicative of the plurality of second NF nodes 30, 40, 50, 60 (“NFp-1”, “NFp-2”, “NFp-3”, “NFp-4”) for providing the service. For example, the plurality of second NF nodes 30, 40, 50, 60 may each be of the same type as that identified by a discovery parameter of the one or more discovery parameters. The discovery response can also comprise information indicative of the set to which the plurality of second NF nodes 30, 40, 50, 60 belong, namely that the second NF nodes “NFp-1” 30 and “NFp-2” 40 belong to the first set of second NF nodes and the second NF nodes “NFp-3” 50 and “NFp-4” 60 belong to the second set of second NF nodes (e.g. “NFp-1:NF-set-1”, “NFp-2:NF-set-1”, “NFp-3:NF-set-2”, “NFp-4:NF-set-2).

Although discovery has been described for the purpose of the embodiment illustrated in FIG. 7, it will be understood that the discovery process is optional. For example, in other embodiments, the discovery results may have previously been obtained and stored (or cached) in a memory, such as the memory 14 of the first SCP node 10. In these embodiments, the steps illustrated by block 406 and arrows 408 and 410 are not required. Instead, the first SCP node 10 can retrieve the information indicative of the plurality of second NF nodes 30, 40, 50, 60 from a memory (e.g. the memory 14 of the first SCP node 10).

After performing the discovery process described with reference to arrows 408 and 410 of FIG. 7 to acquire information indicative of the plurality of second NF nodes 30, 40, 50, 60 (or, alternatively, after retrieving information indicative of the plurality of second NF nodes 30, 40, 50, 60 from previously cached discovery results) and before performing any selection of one or more second NF nodes, the first SCP node 10 may check the received service request for the indication. For example, the first SCP node 10 may check if the service request needs to be forked to multiple targets.

As illustrated by block 412 of FIG. 7, the first SCP node 10 selects one or more second NF nodes of the plurality of second NF nodes 30, 40, 50, 60 to which to transmit the service request received from the first NF node 20. As mentioned earlier, the service request comprises the indication that the service request is to be transmitted to one or more second NF nodes of the plurality of second NF nodes 30, 40, 50, 60 for the service request to be applied to all wireless devices served by the plurality of second NF nodes. Thus, the first SCP node 10 selects one or more second NF nodes of the plurality of second NF nodes 30, 40, 50, 60 so as to ensure that the service request is applied to all wireless devices served by the plurality of second NF nodes. For example, if the service request needs to be forked to multiple targets, the first SCP node 10 can select multiple second NF nodes. For example, the first SCP node 10 can select all second NF nodes or a second NF node within each set (e.g. according to the NfSetId as mentioned earlier), group (e.g. according to the NfGroupId as mentioned earlier), or service set (according to the NfServiceSetId as mentioned earlier), etc. The selection can be based on the forking method if this is provided. In the embodiment illustrated in FIG. 7, the first SCP node 10 selects two second NF nodes “NFp-1” 30 and “NFp-3” 50. The reason for this selection is that these two second NF nodes “NFp-1” 30 and “NFp-3” 50 are part of different sets of second NF nodes that service different wireless devices. A second NF node from each set is selected to ensure that the service request can be applied to all of the wireless devices served by the plurality of second NF nodes 30, 40, 50, 60.

As illustrated by arrow 414 of FIG. 7, the first SCP node 10 transmits the service request towards the selected second NF node “NFp-1” 30. The selected second NF node “NFp-1” 30 thus receives the service request. As illustrated by block 416 of FIG. 7, the selected second NF node “NFp-1” 30 applies the service request to all of the wireless devices (“UEs 1-10”) that it serves. As illustrated by arrow 418 of FIG. 7, the first SCP node 10 also transmits the service request towards the selected second NF node “NFp-3” 50. The selected second NF node “NFp-3” 50 thus receives the service request. As illustrated by block 420 of FIG. 7, the selected second NF node “NFp-3” 50 applies the service request to all of the wireless devices (“UEs 11-20”) that it serves.

Thus, in the embodiment illustrated in FIG. 7, the first SCP node 10 forks the service request to the multiple targets that are selected. Each target can be managed in parallel, rather than in serial. That is, the forking can be parallel, rather than serial. For example, if the selected second NF node within a given set is not reachable, the first SCP node 10 can failover to another second NF node within the same set, e.g. in the usual manner.

As illustrated by arrow 422 of FIG. 7, the first SCP node 10 transmits a response to the service request towards the first NF node 20. The response can be indicative of whether the service request is complete or partially complete. The response is indicative that the service request is complete when every second NF node (“NFp-1” 30, “NFp-3” 50), towards which transmission of the service request is initiated, has successfully executed the service request. For example, the first SCP node 10 may consider the request from the first NF node 20 as completed only when a second NF node from each set of second NF nodes (or any other forking method) has accepted the request. The response is indicative that the service request is partially complete when not every second NF node (“NFp-1” 30, “NFp-3” 50), towards which transmission of the service request is initiated, has successfully executed the service request. In some embodiments, the response can be indicative that the service request is partially completed by comprising a (new) cause code.

If the response is indicative that the service request is partially complete, in some embodiments, the response may comprise an indication of which one or more second NF nodes, towards which transmission of the service request is initiated, have not successfully executed the service request. For example, together with a (new) cause code, the first SCP node 10 may include the set(s) of second NF nodes that have not accepted the service request. In this way, the first NF node 20 is informed of any failure. In some embodiments where there is a failure, transmission to the service request towards the second NF node concerned (or another second NF node of the failed set) may be re-attempted.

As illustrated by block 424 of FIG. 7, the service request is advantageously applied to all wireless devices (“UEs 1-20”). Thus, the method illustrated in FIG. 7 allows all wireless devices to be targeted where an indirect communication model with delegated discovery (e.g. as described earlier with reference to FIG. 1D) is deployed.

The wireless devices referred to herein can comprise any type, and any combination of types, of wireless device. Examples of a type of wireless device as referred to herein include, but are not limited to, a user equipment (UE), such as a smart phone, a mobile phone, a cell phone, a voice over IP (VoIP) phone, a wireless local loop phone, a desktop computer, a personal digital assistant (PDA), a wireless camera, a gaming console or device, a music storage device, a playback appliance, a wearable terminal device, a wireless endpoint, a mobile station, a tablet, a laptop, a laptop-embedded equipment (LEE), a laptop-mounted equipment (LME), a smart device, a wireless customer-premise equipment (CPE), a vehicle-mounted wireless terminal device, etc. The wireless device as referred to herein may support device-to-device (D2D) communication, for example, by implementing a third generation partnership project (3GPP) standard for sidelink communication, vehicle-to-vehicle (V2V), vehicle-to-infrastructure (V2I), vehicle-to-everything (V2X) and may in this case be referred to as a D2D communication device.

As yet another specific example, in an Internet of Things (IoT) scenario, the wireless device as referred to herein may represent a machine or other device that performs monitoring and/or measurements, and transmits the results of such monitoring and/or measurements to another wireless device and/or a network node. The wireless device as referred to herein may in this case be a machine-to-machine (M2M) device, which may in a 3GPP context be referred to as a machine type communication (MTC) device. As one particular example, the wireless device as referred to herein may be a user equipment (UE), e.g. implementing the 3GPP narrow band internet of things (NB-IoT) standard. Particular examples of such machines or devices are sensors, metering devices such as power meters, industrial machinery, or home or personal appliances (e.g. refrigerators, televisions, etc), personal wearables (e.g. watches, fitness trackers, etc). In other scenarios, the wireless device as referred to herein may represent a vehicle or other equipment that is capable of monitoring and/or reporting on its operational status or other functions associated with its operation. The wireless device as referred to herein may represent the endpoint of a wireless connection, in which case the wireless device as referred to herein may be referred to as a wireless terminal. Furthermore, the wireless device as referred to herein may be mobile, in which case it may also be referred to as a mobile device or a mobile terminal.

Other embodiments include those defined in the following numbered statements:

Embodiment 1. A method for handling a service request in a network, wherein the method is performed by a first network function, NF, node (20) of a service consumer, the method comprising:
initiating transmission (202, 404) of a service request towards a first service communication proxy, SCP, node (10) that is configured to operate as an SCP between the first NF node (20) and a plurality of second NF nodes (30, 40, 50, 60) of one or more service producers,
wherein the service request is for a service requested by the first NF node (20) and the service request comprises an indication that the service request is to be transmitted to one or more second NF nodes (30, 50) of the plurality of second NF nodes (30, 40, 50, 60) for the service request to be applied to all wireless devices served by the plurality of second NF nodes (30, 40, 50, 60).

Embodiment 2. A method according to Embodiment 1, wherein:
the service request comprises a first hypertext transfer protocol, HTTP, header and the first HTTP header comprises the indication.

Embodiment 3. A method according to Embodiment 1 or 2, wherein:
the service request comprises a criterion on the basis of which the one or more second NF nodes (30, 50) are to be selected by the first SCP node (10).

Embodiment 4. A method according to Embodiment 3, wherein:
the criterion is that the one or more second NF nodes (30, 50) are to comprise:
   a second NF node that has a predefined group identifier or at least two second NF nodes that have different group identifiers;
   a second NF node that has a predefined set identifier or at least two second NF nodes that have different set identifiers; and/or
   a second NF node that has a predefined service set identifier or at least two second NF nodes that have different service set identifiers.

Embodiment 5. A method according to Embodiment 3, wherein:
the criterion is that the one or more second NF nodes (30, 50) are to comprise all second NF nodes of the plurality of second NF nodes (30, 40, 50, 60).

Embodiment 6. A method according to any of Embodiments 3 to 5, wherein:
the service request comprises a second hypertext transfer protocol, HTTP, header and the second HTTP header comprises the criterion.

Embodiment 7. A method according to any of the preceding Embodiments, the method comprising:
receiving (422) a response to the service request from the first SCP node (10), wherein the response is indicative of whether the service request is complete or partially complete.

Embodiment 8. A method according to Embodiment 7, wherein:
the response is indicative that the service request is complete when every second NF node, towards which transmission of the service request is initiated, has successfully executed the service request; and/or
the response is indicative that the service request is partially complete when not every second NF node, towards which transmission of the service request is initiated, has successfully executed the service request.

Embodiment 9. A method according to Embodiment 7 or 8, wherein:
the response is indicative that the service request is partially complete and the response comprises an indication of which one or more second NF nodes, towards which transmission of the service request is initiated, have not successfully executed the service request.

Embodiment 10. A method according to any of the preceding Embodiments, wherein:
the wireless devices are in a single public land mobile network, PLMN, or a plurality of PLMNs.

Embodiment 11. A method according to any of the preceding Embodiments, wherein:
the service is a service that provides a notification to the first NF node (20) of a change to an international mobile equipment identity, IMEI, or a permanent equipment identifier, PEI, for any of the wireless devices; or
the service is a service that provides a notification to the first NF node (20) of any of the wireless devices moving to a different public land mobile network, PLMN.

Embodiment 12. A method according to any of the preceding Embodiments, wherein:
the first SCP node (10) and the first NF node (20) are deployed in independent deployment units; and/or
the first SCP node (10) and any one or more of the plurality of second NF nodes (30, 40, 50, 60) are deployed in independent deployment units.

Embodiment 13. A method according to any of Embodiments 1 to 11, wherein:
the first SCP node (10) is deployed as a distributed network element.

Embodiment 14. A method according to Embodiment 13, wherein:
part of the first SCP node (10) is deployed in the same deployment unit as the first NF node (20); and/or
part of the first SCP node (10) is deployed in the same deployment unit as any one or more of the plurality of second NF nodes (30, 40, 50, 60).

Embodiment 15. A method according to any of the preceding Embodiments, wherein:
at least one second SCP node is configured to operate as an SCP between the first NF node (20) and the first SCP node (10); and/or
at least one third SCP node is configured to operate as an SCP between the first SCP node (10) and any one or more of the plurality of second NF nodes (30, 40, 50, 60).

Embodiment 16. A method according to Embodiment 15, wherein:
the first SCP node (10) and the at least one second SCP node and/or the at least one third SCP node are deployed in independent deployment units.

Embodiment 17. A method according to Embodiment 15, wherein:
the at least one second SCP node and/or the at least one third SCP node are deployed as distributed network elements.

Embodiment 18. A method according to any of the preceding Embodiments, wherein:
an entity comprises the first SCP node (10) and a network repository function, NRF node (70).

Embodiment 19. A method for handling a service request in a network, wherein the method is performed by a first service communication proxy, SCP, node (10) that is configured to operate as an SCP between a first network function, NF, node (20) of a service consumer and a plurality of second NF nodes (30, 40, 50, 60) of one or more service producers, the method comprising:
selecting (102, 412) one or more second NF nodes (30, 50) of the plurality of second NF nodes (30, 40, 50, 60) to which to transmit a service request received from the first NF node (20),
wherein the service request is for a service requested by the first NF node (20) and the service request comprises an indication that the service request is to be transmitted to one or more second NF nodes (30, 50) of the plurality of second NF nodes (30, 40, 50, 60) for the service request to be applied to all wireless devices served by the plurality of second NF nodes (30, 40, 50, 60).

Embodiment 20. A method according to Embodiment 19, wherein:
the service request comprises a first hypertext transfer protocol, HTTP, header and the first HTTP header comprises the indication.

Embodiment 21. A method according to Embodiment 19 or 20, wherein:
the service request comprises a criterion on the basis of which the one or more second NF nodes (30, 50) are to be selected by the first SCP node (10); and
selecting (102, 412) the one or more second NF nodes (30, 50) comprises selecting the one or more second NF nodes (30, 50) based on the criterion.

Embodiment 22. A method according to Embodiment 21, wherein:
the criterion is that the one or more second NF nodes (30, 50) are to comprise a second NF node that has a predefined group identifier and selecting the one or more second NF nodes (30, 50) comprises selecting a second NF node that has the predefined group identifier, or the criterion is that the one or more second NF nodes (30, 50) are to comprise at least two second NF nodes that have different group identifiers and selecting the one or more second NF nodes (30, 50) comprises selecting at least two second NF nodes that have different group identifiers;
the criterion is that the one or more second NF nodes (30, 50) are to comprise a second NF node that has a predefined set identifier and selecting the one or more second NF nodes (30, 50) comprises selecting a second NF node that has the predefined set identifier, or the criterion is that the one or more second NF nodes (30, 50) are to comprise at least two second NF nodes that have different set identifiers and selecting the one or more second NF nodes (30, 50) comprises selecting at least two second NF nodes that have different set identifiers; and/or
the criterion is that the one or more second NF nodes (30, 50) are to comprise a second NF node that has a predefined service set identifier and selecting the one or more second NF nodes (30, 50) comprises selecting a second NF node that has the predefined service set identifier, or the criterion is that the one or more second NF nodes (30, 50) are to comprise at least two second NF nodes that have different service set identifiers and selecting the one or more second NF nodes (30, 50) comprises selecting at least two second NF nodes that have different service set identifiers.

Embodiment 23. A method according to Embodiment 21, wherein:
the criterion is that the one or more second NF nodes (30, 50) are to comprise all second NF nodes of the plurality of second NF nodes (30, 40, 50, 60); and
selecting the one or more second NF nodes (30, 50) comprises selecting all second NF nodes of the plurality of second NF nodes (30, 40, 50, 60).

Embodiment 24. A method according to any of Embodiments 19 to 23, wherein:
the service request comprises a second hypertext transfer protocol, HTTP, header and the second HTTP header comprises the criterion.

Embodiment 25. A method according to any of Embodiments 19 to 24, the method comprising:
checking the service request for the indication.

Embodiment 26. A method according to any of Embodiments 19 to 25, the method comprising:
prior to selecting (102, 412) the one or more second NF nodes (30, 50), initiating transmission (408) of a discovery request towards a network repository function, NRF, node (70), wherein the discovery request is a request for information indicative of one or more second NF nodes for providing the service; and
receiving (410) a discovery response from the NRF node (70), wherein the discovery response comprises information indicative of the plurality of second NF nodes (30, 40, 50, 60) for providing the service.

Embodiment 27. A method according to any of Embodiments 19 to 26, the method comprising:
initiating transmission (414, 418) of the service request towards the selected one or more second NF nodes (30, 50).

Embodiment 28. A method according to Embodiment 27, the method comprising:
for each second NF node of the selected one or more second NF nodes (30, 50) that is unreachable, selecting an alternative second NF node of the plurality of second NF nodes (30, 40, 50, 60) for the service request to be applied to all wireless devices served by the plurality of second NF nodes (30, 40, 50, 60).

Embodiment 29. A method according to Embodiment 28 when directly or indirectly dependent on Embodiment 21, wherein:
selecting the alternative second NF node comprises selecting the alternative second NF node based on the criterion.

Embodiment 30. A method according to Embodiment 28 or 29, the method comprising:
initiating transmission of the service request towards the selected alternative second NF node.

Embodiment 31. A method according to any of Embodiments 19 to 30, the method comprising:
initiating transmission (422) of a response to the service request towards the first NF node (20), wherein the response is indicative of whether the service request is complete or partially complete.

Embodiment 32. A method according to Embodiment 31, wherein:
the response is indicative that the service request is complete when every second NF node, towards which transmission of the service request is initiated, has successfully executed the service request; and/or
the response is indicative that the service request is partially complete when not every second NF node, towards which transmission of the service request is initiated, has successfully executed the service request.

Embodiment 33. A method according to Embodiment 31 or 32, wherein:
the response is indicative that the service request is partially complete and the response comprises an indication of which one or more second NF nodes, towards which transmission of the service request is initiated, have not successfully executed the service request.

Embodiment 34. A method according to any of Embodiments 19 to 33, wherein:
the wireless devices are in a single public land mobile network, PLMN, or a plurality of PLMNs.

Embodiment 35. A method according to any of Embodiments 19 to 34, wherein:
the service is a service that provides a notification to the first NF node (20) of a change to an international mobile equipment identity, IMEI, or a permanent equipment identifier, PEI, for any of the wireless devices; or
the service is a service that provides a notification to the first NF node (20) of any of the wireless devices moving to a different public land mobile network, PLMN.

Embodiment 36. A method according to any of Embodiments 19 to 35, wherein:
the first SCP node (10) and the first NF node (20) are deployed in independent deployment units; and/or
the first SCP node (10) and any one or more of the plurality of second NF nodes (30, 40, 50, 60) are deployed in independent deployment units.

Embodiment 37. A method according to any of Embodiments 19 to 35, wherein:
the first SCP node (10) is deployed as a distributed network element.

Embodiment 38. A method according to Embodiment 37, wherein:
part of the first SCP node (10) is deployed in the same deployment unit as the first NF node (20); and/or
part of the first SCP node (10) is deployed in the same deployment unit as any one or more of the plurality of second NF nodes (30, 40, 50, 60).

Embodiment 39. A method according to any of Embodiments 19 to 38, wherein:
at least one second SCP node is configured to operate as an SCP between the first NF node (20) and the first SCP node (10); and/or
at least one third SCP node is configured to operate as an SCP between the first SCP node (10) and any one or more of the plurality of second NF nodes (30, 40, 50, 60).

Embodiment 40. A method according to Embodiment 39, wherein:
the first SCP node (10) and the at least one second SCP node and/or the at least one third SCP node are deployed in independent deployment units.

Embodiment 41. A method according to Embodiment 39, wherein:
the at least one second SCP node and/or the at least one third SCP node are deployed as distributed network elements.

Embodiment 42. A method according to any of Embodiments 19 to 41, wherein:
an entity comprises the first SCP node (10) and a network repository function, NRF node (70).

Embodiment 43. A method performed by a system, the method comprising:
the method according to any of Embodiments 1 to 18; and/or
the method according to any of Embodiments 19 to 42.

Embodiment 44. A first network function, NF, node (20) comprising:
processing circuitry (22) configured to operate in accordance with any of Embodiments 1 to 18.

Embodiment 45. A first NF node (20) according to Embodiment 44, wherein:
the first NF node (20) comprises:
   at least one memory (24) for storing instructions which, when executed by the processing circuitry (22), cause the first NF node (20) to operate in accordance with any of Embodiments 1 to 18.

Embodiment 46. A first service communication proxy, SCP, node (10) comprising:
processing circuitry (12) configured to operate in accordance with any of Embodiments 19 to 42.

Embodiment 47. A first SCP node (10) according to Embodiment 46, wherein:
the first SCP node (10) comprises:
   at least one memory (14) for storing instructions which, when executed by the processing circuitry (12), cause the first SCP node (10) to operate in accordance with any of Embodiments 19 to 42.

Embodiment 48. A system comprising:
at least one first NF node (20) according to Embodiment 44 or 45; and
at least one first SCP node (10) according to Embodiment 46 or 47.

Embodiment 49. A computer program comprising instructions which, when executed by processing circuitry, cause the processing circuitry to perform the method according to any of Embodiments 1 to 18 and/or any of Embodiments 19 to 42.

Embodiment 50. A computer program product, embodied on a non-transitory machine-readable medium, comprising instructions which are executable by processing circuitry to cause the processing circuitry to perform the method according to any of Embodiments 1 to 18 and/or any of Embodiments 19 to 42.

There is also provided a computer program comprising instructions which, when executed by processing circuitry (such as the processing circuitry 12 of the first SCP node 10 described earlier and/or the processing circuitry 22 of the first NF node 20 described earlier), cause the processing circuitry to perform at least part of the method described herein. There is provided a computer program product, embodied on a non-transitory machine-readable medium, comprising instructions which are executable by processing circuitry (such as the processing circuitry 12 of the first SCP node 10 described earlier and/or the processing circuitry 22 of the first NF node 20 described earlier) to cause the processing circuitry to perform at least part of the method described herein. There is provided a computer program product comprising a carrier containing instructions for causing processing circuitry (such as the processing circuitry 12 of the first SCP node 10 described earlier and/or the processing circuitry 22 of the first NF node 20 described earlier) to perform at least part of the method described herein. In some embodiments, the carrier can be any one of an electronic signal, an optical signal, an electromagnetic signal, an electrical signal, a radio signal, a microwave signal, or a computer-readable storage medium.

In some embodiments, the node functionality described herein can be performed by hardware. Thus, in some embodiments, any one or more of the first SCP node 10 and the first NF node 20 described herein can be a hardware node. However, it will also be understood that optionally at least part or all of the node functionality described herein can be virtualized. For example, the functions performed by any one or more of the first SCP node 10 and the first NF node 20 described herein can be implemented in software running on generic hardware that is configured to orchestrate the node functionality. Thus, in some embodiments, any one or more of the first SCP node 10 and the first NF node 20 described herein can be a virtual node. In some embodiments, at least part or all of the node functionality described herein may be performed in a network enabled cloud. The node functionality described herein may all be at the same location or at least some of the node functionality may be distributed.

It will be understood that at least some or all of the method steps described herein can be automated in some embodiments. That is, in some embodiments, at least some or all of the method steps described herein can be performed automatically. The method described herein can be a computer-implemented method.

Thus, in the manner described herein, there is advantageously provided an improved technique for handling a service request in a network. In particular, the technique described herein can allow indirect routing with delegated discovery for scenarios where the first NF node 20 intends to target all wireless devices (e.g. in a PLMN). These are scenarios where the first NF node 20 does not need to perform a discovery directly to the NRF node 70. In particular, in these scenarios, the first NF node 20 is unable to itself find and manage one or more suitable second NF nodes, which means that it is not possible for the first NF node 20 to target (e.g. fork) the one or more second NF nodes necessary for the service request to be applied to all wireless devices. Thus, the first SCP node 10 takes responsibility for the initial and optionally also any reselection that may be needed.

There are many use cases to which the technique described herein is applicable, such as any of those where (e.g. 5GC) services allow the sender (the first NF node) to send a request targeting all (or any) wireless devices (e.g. in a PLMN). One example use case is where the first NF node 20 requests to receive notifications when any of the mobile network operator (MNO) users perform a “subscriber identity module (SIM) swap”. That is, when there is an IMEI/PEI change (e.g. because a user has purchased a new wireless device, e.g. smartphone) in the network. Another example use case relates to monitoring a roaming status change for all wireless devices. For example, the MNO may be interested in knowing how often their users become roamers and stop becoming roamers. That is, the MNO may be interested in knowing how often their users move to a visited country/PLMN and return to their home country/PLMN. However, although some example use cases have been described, it will be understood that the technique described herein is also applicable to many other use cases.

It should be noted that the above-mentioned embodiments illustrate rather than limit the idea, and that those skilled in the art will be able to design many alternative embodiments without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

1. A method for handling a service request in a network, wherein the method is performed by a first network function (NF) node of a service consumer, the method comprising:
initiating transmission of a service request towards a first service communication proxy (SCP) node that is configured to operate as an SCP between the first NF node and a plurality of second NF nodes of one or more service producers, wherein
the service request is for a service requested by the first NF node, and
the service request comprises an indication that the service request is to be transmitted to one or more second NF nodes of the plurality of second NF nodes for the service request to be applied to all wireless devices served by the plurality of second NF nodes.

2. The method of claim 1, wherein:
the service request comprises a first hypertext transfer protocol, HTTP, header and the first HTTP header comprises the indication.

3. The method of claim 1, wherein:
the service request comprises a criterion on the basis of which the one or more second NF nodes are to be selected by the first SCP node.

4. The method of claim 3, wherein:
the criterion is that the one or more second NF nodes are to comprise:
a second NF node that has a predefined group identifier or at least two second NF nodes that have different group identifiers;
a second NF node that has a predefined set identifier or at least two second NF nodes that have different set identifiers; and/or
a second NF node that has a predefined service set identifier or at least two second NF nodes that have different service set identifiers.

5. The method of claim 3, wherein:
the criterion is that the one or more second NF nodes are to comprise all second NF nodes of the plurality of second NF nodes.

6. The method of claim 3, wherein:
the service request comprises a second hypertext transfer protocol (HTTP) header and the second HTTP header comprises the criterion.

7. The method of claim 1, further comprising:
receiving a response to the service request from the first SCP node, wherein the response is indicative of whether the service request is complete or partially complete.

8. The method of claim 7, wherein:
the response is indicative that the service request is complete when every second NF node, towards which transmission of the service request is initiated, has successfully executed the service request; and/or
the response is indicative that the service request is partially complete when not every second NF node, towards which transmission of the service request is initiated, has successfully executed the service request.

9. The method of claim 7, wherein:
the response is indicative that the service request is partially complete, and
the response comprises an indication of which one or more second NF nodes, towards which transmission of the service request is initiated, have not successfully executed the service request.

10. The method of claim 1, wherein:
the wireless devices are in a single public land mobile network (PLMN) or a plurality of PLMNs.

11. The method of claim 1, wherein:
the service is a service that provides a notification to the first NF node of a change to an international mobile equipment identity (IMEI) or a permanent equipment identifier (PEI) for any of the wireless devices; or
the service is a service that provides a notification to the first NF node of any of the wireless devices moving to a different public land mobile network (PLMN).

12. A method for handling a service request in a network, wherein the method is performed by a first service communication proxy (SCP) node that is configured to operate as an SCP between a first network function (NF) node of a service consumer and a plurality of second NF nodes of one or more service producers, the method comprising:
selecting one or more second NF nodes of the plurality of second NF nodes to which to transmit a service request received from the first NF node, wherein
the service request is for a service requested by the first NF node, and
the service request comprises an indication that the service request is to be transmitted to one or more second NF nodes of the plurality of second NF nodes for the service request to be applied to all wireless devices served by the plurality of second NF nodes.

13. (canceled)

14. The method of claim 12, wherein:
the service request comprises a criterion on the basis of which the one or more second NF nodes are to be selected by the first SCP node; and
selecting the one or more second NF nodes comprises selecting the one or more second NF nodes based on the criterion.

15. The method of claim 14, wherein:
the criterion is that the one or more second NF nodes are to comprise a second NF node that has a predefined group identifier and selecting the one or more second NF nodes comprises selecting a second NF node that has the predefined group identifier, or the criterion is that the one or more second NF nodes are to comprise at least two second NF nodes that have different group identifiers and selecting the one or more second NF nodes comprises selecting at least two second NF nodes that have different group identifiers;
the criterion is that the one or more second NF nodes are to comprise a second NF node that has a predefined set identifier and selecting the one or more second NF nodes comprises selecting a second NF node that has the predefined set identifier, or the criterion is that the one or more second NF nodes are to comprise at least two second NF nodes that have different set identifiers and selecting the one or more second NF nodes comprises selecting at least two second NF nodes that have different set identifiers; and/or
the criterion is that the one or more second NF nodes are to comprise a second NF node that has a predefined service set identifier and selecting the one or more second NF nodes comprises selecting a second NF node that has the predefined service set identifier, or the criterion is that the one or more second NF nodes are to comprise at least two second NF nodes that have different service set identifiers and selecting the one or more second NF nodes comprises selecting at least two second NF nodes that have different service set identifiers.

16. The method of claim 14, wherein:
the criterion is that the one or more second NF nodes are to comprise all second NF nodes of the plurality of second NF nodes; and
selecting the one or more second NF nodes comprises selecting all second NF nodes of the plurality of second NF nodes.

17. The method of claim 12, wherein:
the service request comprises a second hypertext transfer protocol, HTTP, header and the second HTTP header comprises the criterion.

18-26. (canceled)

27. A first network function (NF) node comprising:
memory; and
processing circuitry, wherein
the first NF node is configured to perform the method of claim 1.

28. (canceled)

29. A first service communication proxy (SCP) node comprising:
memory; and
processing circuitry, wherein
the first SCP node is configured to perform the method of claim 12.

30. (canceled)

31. (canceled)

32. A non-transitory computer readable storage medium storing a computer program comprising instructions which, when executed by processing circuitry, cause the processing circuitry to perform the method of claim 1.

33. (canceled)

34. A non-transitory computer readable storage medium storing a computer program comprising instructions which, when executed by processing circuitry, cause the processing circuitry to perform the method of claim 12.
